(19) United States
(12) Patent Application Publication
(10) Pub. No.: US 2017/0279317 A1
(43) Pub. Date: Sep. 28, 2017

(54) Silicon steel sheet for motor

(71) Applicant: Ming-Chang LEE, Taipei City 111 (TW)

(72) Inventor: Ming-Chang LEE, Taipei City 111 (TW)

(21) Appl. No.: 15/077,926

(22) Filed: Mar. 23, 2016

(51) Int. Cl. H02K 1/14; H02K 3/32

(52) U.S. Cl. CPC H02K 1/14; H02K 3/325

(57) ABSTRACT

A silicon steel sheet for a motor contains: a peripheral extension, a plurality of main teeth, multiple auxiliary teeth, a plurality of first pole shoes, and multiple second pole shoes. Each main tooth is separated from each auxiliary tooth and is defined between any two auxiliary teeth, and each first pole shoe is in connection with any two main teeth, and each second pole shoe is coupled with any two auxiliary teeth. Said each first pole shoe, said each second pole shoe, said each main tooth, and said each auxiliary tooth define an accommodation space configured to house at least one electrical wire. Between said each first pole shoe and said each second pole shoe is defined an opening so that the at least one electrical wire is housed in the accommodation space via the opening.

### FIELD OF THE INVENTION

The present invention relates to a silicon steel sheet for a motor in which a number of winding circles of at least one electrical wire around each main tooth is more than that around each auxiliary tooth by way of a first angle and a second angle so as to reduce a length of the at least one electrical wire.

### BACKGROUND OF THE INVENTION

At present, a brushless DC motor replaces conventional DC motor and conventional AC motor which are applicable for printers, sports apparatus, air conditioners, fans and digital equipment, etc.

The brushless DC motor contains a rotor and a stator on which at least one electrical wire is winded. After conducting electricity, the at least one electrical wire produces electromagnetic interaction by which the rotor is driven to swivel relative to the stator. The stator contains a plurality of silicon steel sheets stacked together.

Each silicon steel sheet has a peripheral extension on which multiple teeth are formed, and between any two teeth is defined an accommodation space, and each tooth has a pole shoe arranged on a free end thereof, wherein any two pole shoes of said any two teeth are spaced by an opening, such that the at least one electrical wire is housed in the accommodation space via the opening.

However, angles of the multiple teeth are identical, respectively, so a number of winding circles of the at least one electrical wire is too high to reduce a length of the at least one electrical wire.

Furthermore, as the motor rotates, the silicon steel sheet makes noises loudly and causes vibration.

The present invention has arisen to mitigate and/or obviate the afore-described disadvantages.

### SUMMARY OF THE INVENTION

The primary objective of the present invention is to provide a silicon steel sheet for a motor in which a number of winding circles of at least one electrical wire around each main tooth is more than that around each auxiliary tooth by way of a first angle and a second angle so as to reduce a length of the at least one electrical wire.

Another objective of the present invention is to provide a silicon steel sheet for a motor in which each first pole shoe has two first cutouts, and each second pole shoe has two second cutouts, and a distance between each first cutout and an opening adjacent to said each first cutout is fixed, a distance between each second cutout and the opening adjacent to said each second cutout is fixed so as to decrease cogging torque, vibration and noise as the motor rotates.

To obtain above-mentioned objectives, a silicon steel sheet for a motor provided by the present invention contains: a peripheral extension, a plurality of main teeth, multiple auxiliary teeth, a plurality of first pole shoes, and multiple second pole shoes.

Each main tooth is separated from each auxiliary tooth and is defined between any two auxiliary teeth, and each first pole shoe is in connection with any two main teeth, and each second pole shoe is coupled with any two auxiliary teeth.

Said each first pole shoe, said each second pole shoe, said each main tooth, and said each auxiliary tooth define an accommodation space configured to house at least one electrical wire.

Between said each first pole shoe and said each second pole shoe is defined an opening so that the at least one electrical wire is housed in the accommodation space via the opening.

Preferably, the peripheral extension includes an external fringe in a quadrangle shape and includes an internal fringe in an octagon shape, wherein the internal fringe has multiple first sections and multiple second sections, and each first section is parallel to the external fringe of the peripheral extension and is one-piece formed with said each main tooth, and among any two first sections and a center of the peripheral extension is defined a first angle; wherein each second section is not parallel to the external fringe of the peripheral extension and is one-piece formed with said each auxiliary tooth, and among any two second sections and the center of the peripheral extension is defined a second angle; wherein a ratio of the first angle against the second angle is 8:7 or 7:8.

Preferably, the first angle is 48 degrees, and the second angle is 42 degrees.

Preferably, the first angle is 42 degrees, and the second angle is 48 degrees.

Preferably, said each first pole shoe has two first cutouts, and said each second pole shoe has two second cutouts.

### BRIEF DESCRIPTION OF THE DRAWINGS

FIG. 1 is a side plan view showing the assembly of a silicon steel sheet for a motor according to a preferred embodiment of the present invention.

### DETAILED DESCRIPTION OF THE PREFERRED EMBODIMENTS

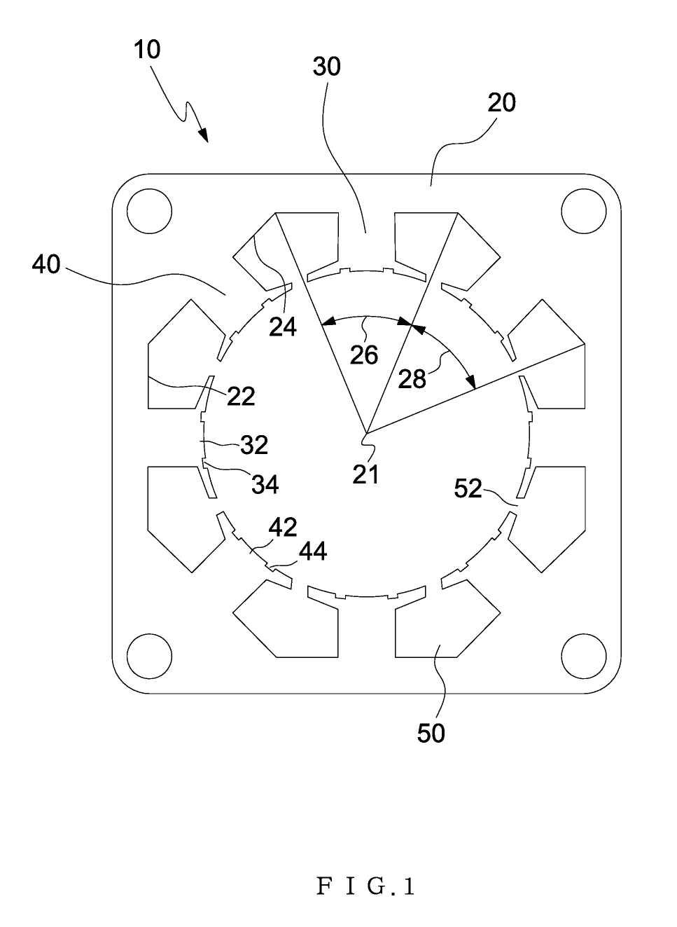

With reference to FIG. 1, a silicon steel sheet 10 for a motor according to a preferred embodiment of the present invention is polygonal and has a thickness of 13 mm The silicon steel sheet 10 comprises: a peripheral extension 20, a plurality of main teeth 30, multiple auxiliary teeth 40, a plurality of first pole shoes 32, and multiple second pole shoes 42.

The peripheral extension 20 includes an external fringe in a quadrangle shape and includes an internal fringe in an octagon shape, wherein the internal fringe has multiple first sections 22 and multiple second sections 24. In another embodiment, the external fringe and the internal fringe of the peripheral extension 20 are in a geometry shape.

Each first section 22 is parallel to the external fringe of the peripheral extension 20 and is one-piece formed with each main tooth 30, and among any two first sections 22 and a center 21 of the peripheral extension 20 is defined a first angle 26.

Each second section 24 is not parallel to the external fringe of the peripheral extension 20 and is one-piece formed with each auxiliary tooth 40, and among any two second sections 24 and the center 21 of the peripheral extension 20 is defined a second angle 28.

The first angle 26 is 48 degrees, and the second angle 29 is 42 degrees, so a ratio of the first angle 26 against the second angle 28 is 8:7. In another embodiment, the first angle 26 is 42 degrees, and the second angle 28 is 48 degrees, so a ratio of the first angle 26 against the second angle 28 is 7:8.

Said each main tooth 30 is separated from said each auxiliary tooth 40 and is defined between any two auxiliary teeth 40, and each first pole shoe 32 is in connection with any two main teeth 30, and each second pole shoe 42 is coupled with said any two auxiliary teeth 40. Said each first pole shoe 32, said each second pole shoe 42, said each main tooth 30, and said each auxiliary tooth 40 define an accommodation space 50 configured to house at least one electrical wire (not shown). Between said each first pole shoe 32 and said each second pole shoe 42 is defined an opening 52 so that the at least one electrical wire is housed in the accommodation space 50 via the opening 52.

Thereby, a number of winding circles of the at least one electrical wire around said each main tooth 30 is more than that around said each auxiliary tooth 40 by way of said first angle 26 and the second angle 28 so as to reduce a length of the at least one electrical wire.

In addition, said each first pole shoe 32 has two first cutouts 34, said each second pole shoe 42 has two second cutouts 44, and a distance between each first cutout 34 and the opening 50 adjacent to said each first cutout 34 is fixed, a distance between each second cutout 44 and the opening 50 adjacent to said each second cutout 44 is fixed so as to decrease cogging torque, vibration and noise as the motor rotates.

While the preferred embodiments of the invention have been set forth for the purpose of disclosure, modifications of the disclosed embodiments of the invention and other embodiments thereof may occur to those skilled in the art. Accordingly, the appended claims are intended to cover all embodiments which do not depart from the spirit and scope of the invention.

What is claimed is:

1. A silicon steel sheet for a motor comprising: a peripheral extension, a plurality of main teeth, multiple auxiliary teeth, a plurality of first pole shoes, and multiple second pole shoes;
wherein each main tooth is separated from each auxiliary tooth and is defined between any two auxiliary teeth, and each first pole shoe is in connection with any two main teeth, and each second pole shoe is coupled with any two auxiliary teeth;
wherein said each first pole shoe, said each second pole shoe, said each main tooth, and said each auxiliary tooth define an accommodation space configured to house at least one electrical wire;
wherein between said each first pole shoe and said each second pole shoe is defined an opening so that the at least one electrical wire is housed in the accommodation space via the opening.

2. The silicon steel sheet for the motor as claimed in claim 1, wherein the peripheral extension includes an external fringe in a quadrangle shape and includes an internal fringe in an octagon shape, wherein the internal fringe has multiple first sections and multiple second sections, and each first section is parallel to the external fringe of the peripheral extension and is one-piece formed with said each main tooth, and among any two first sections and a center of the peripheral extension is defined a first angle; wherein each second section is not parallel to the external fringe of the peripheral extension and is one-piece formed with said each auxiliary tooth, and among any two second sections and the center of the peripheral extension is defined a second angle; wherein a ratio of the first angle against the second angle is 8:7 or 7:8.

3. The silicon steel sheet for the motor as claimed in claim 2, wherein the first angle is 48 degrees, and the second angle is 42 degrees.

4. The silicon steel sheet for the motor as claimed in claim 2, wherein the first angle is 42 degrees, and the second angle is 48 degrees.

5. The silicon steel sheet for the motor as claimed in claim 1, wherein said each first pole shoe has two first cutouts, and said each second pole shoe has two second cutouts.
